(19) United States
(12) Patent Application Publication
(10) Pub. No.: US 2005/0057450 A1
(43) Pub. Date: Mar. 17, 2005

(54) Method for controlling address power on plasma display panel and apparatus thereof

(76) Inventor: Jae-Seok Jeong, Suwon-si (KR)

Correspondence Address: McGuire Woods LLP, Suite 1800, 1750 Tysons Boulevard, McLean, VA, 22102, US

(21) Appl. No.: 10/930,949

(22) Filed: Sep. 1, 2004

(30) Foreign Application Priority Data
Sep. 2, 2003 (KR) 2003-0061178

(51) Int. Cl. G09G 3/28

(52) U.S. Cl. 345/60

(57) ABSTRACT

A method for controlling address power on a PDP is disclosed. Image data to be displayed on the PDP is converted into subfield data, and the subfield data is analyzed to generate a variation rate of the image data and a variation of the data per subfield. An address power recovery circuit for each subfield is operated or stopped based on the variation of the data per subfield. Image data are determined to be a normal mode or a specific mode based on the generated variation of the image data, and a gain of the image data on the specific mode is controlled and displayed on the PDP.

### CROSS REFERENCE TO RELATED APPLICATION

This application claims priority of Korean Patent Application No. 2003-61178 filed on Sep. 2, 2003 in the Korean Intellectual Property Office, the disclosure which is herein incorporated by reference.

### BACKGROUND OF THE INVENTION

(a) Field of the Invention

The present invention relates to plasma display panels, generally, and more particularly to an apparatus and method for controlling address power on a plasma display panel.

(b) Description of the Related Art

A plasma display panel (PDP) includes a plurality of discharge cells arranged in a matrix format on a substrate. Images are displayed by selectively emitting various combinations of discharge cells. In this manner, video data input as electric signals is restored as an image that a user can see.

Color PDPs require shades of gray (gray scales) in order to present vibrant color pictures. Gray scales are provided by dividing the display into a plurality of subfields and controlling them in a time-varying manner.

For example, in the subfield method, each subfield is time-divided into a reset period for resetting a full screen, an address period for scanning the full screen in a line scanning manner and for programming data, as well as a sustain period for maintaining an emission state of the cells to which the data is programmed.

At least one address electrode is provided for performing an address operation. Similarly, at least one scan electrode is provided for performing a scan operation. Additionally, at least one common electrode is provided for performing a sustain operation.

When the address electrode is driven in the PDP to display images, about 10 W to 500 W of power is consumed depending on resolution and size of the PDP. Conventionally, an address recovery circuit is used to control the address power consumption. As described, power consumption of the displayed images with steeply increased address power consumption is controlled to some degree by using the address power recovery circuit. However, when an image without increased power consumption is displayed, the power recovery circuit continues to generate, and power consumption increases as a side effect.

The published Korean Patent Application No. 2002-32927 (A Method for Driving an Address Electrode of a Plasma Display Panel) discloses the side effect caused by a displayed image when the address power recovery circuit is operated. In this case, when a variation value of the input image data is less than a reference value, operation of the address power recovery circuit ceases. When the variation value exceeds the reference value, the address power recovery circuit operates to reduce the power consumption. However in the above-noted application, only the variation value of the input image data is generated, and therefore, the address power recovery circuit of the total subfields stops operating when the variation value is small, and operates when the variation value of the data is large. Accordingly, this and prior PDP systems control address power consumption ineffectively because the address data varies for each subfield, and the characteristics of the address power consumption differs for each subfield used to provide gray scales in a PDP.

Also, the higher the PDP's resolution and the wider its panel area become, the more the power is consumed when the address electrode is driven. Thus, it is difficult to control the power consumption using only the address power recovery circuit. A solution is needed that provides an improved apparatus and method for efficiently controlling power consumption in a PDP.

### SUMMARY OF THE INVENTION

In one embodiment, the present invention provides a method and apparatus for analyzing images to be displayed on a Plasma Display Panel(PDP) in order to control an address power recovery operation for each subfield.

In one embodiment of the invention, a method for controlling the address power on the PDP with the address power recovery circuit includes a) converting image data to be displayed on the plasma display panel into comprising subfield data; b) analyzing the converted subfield data to generate a variation of the image data for each subfield; c) stopping operation of the address power recover circuit for subfields having data variations less than a predetermined first threshold value; and d) operating the address power recovery circuit for one or more subfields having data variations greater than a predetermined first threshold value.

In another embodiment, a method for controlling an address power on a PDP, includes a) converting image data to be displayed on the plasma display panel into comprising subfield data; b) analyzing the converted subfield data to generate variation of the image data; and c) controlling gain of the image data when the generated variation of the image data is greater than a predetermined second threshold value.

Analyzing the converted subfield data to generate the variation for each subfield further includes adding the generated variation for each subfield to all subfields to generate the variation of the image data.

In one embodiment, the gain of the image data may be controlled by a gain coefficient bound on the variation of the generated image data in step c). Alternatively, the gain coefficient may be determined in inverse proportion to the variation of the image data. Also, the gain of the image data may be controlled by the gain coefficient on the basis of the time in step c). The gain coefficient may also be reduced as time passes.

In another aspect of the present invention, a method for controlling address power on a PDP includes: a) converting the image data to be displayed on the plasma display panel into corresponding subfield data; b) analyzing the converted subfield data to generate a variation of the image data and variation of the data for each subfield; c) controlling a gain of the image data and operating the address power recovery circuit, when the generated variation of the data for each subfield is greater than a predetermined first threshold value and the generated variation of the image data is greater than the second threshold value; d) operating the address power recovery circuit but not controlling the gain of the image data when the generated variation of the data for each subfield is greater than the predetermined first threshold value and the generated variation of the image data is less than the predetermined second threshold value; and e) controlling the gain of the image data except during operation of the address power recovery circuit.

In another embodiment of the invention, an apparatus for controlling address power on a plasma display panel, includes a data variation calculator that converts image data to be displayed on the PDP into subfield data to generate the variation of the data for each subfield. Additionally, an address power recovery operation determine unit compares the variation of the data for each subfield generated by the data variation calculator with a predetermined first threshold value to determine an operational status of the address power recovery circuit. Also, an address power recovery timing controller generates switch timing of the address power recovery circuit based on the operational status of the address power recovery circuit determined by the address power recovery operation determine unit. Additionally, an address electrode driver drives the address power recovery circuit based on the switch timing generated by the address power recovery circuit.

In another embodiment, an apparatus for controlling address power on a plasma display panel includes a data variation calculator that converts image data to be displayed on the plasma display panel into corresponding subfield data and analyzes the image data to generate a variation of the image data. A mode determine unit compares the variation of the image data generated by the data variation calculator with a predetermined second threshold value to generate a gain control signals of the image data. An image data gain controller controls the gain of the image data according to the control signals generated by the mode determine unit and outputs them. An address data controller converts the image data from the image data gain controller into the corresponding subfield data to drive the plasma display panel and generates address data rearranged to correspond to address timing for each subfield. Additionally, an address electrode driver for initiates address discharges based on address data received from the address data controller to provide them to the PDP.

In another embodiment, an apparatus for controlling address power on a plasma display panel includes a data variation calculator to convert image data to be displayed on the plasma display panel into corresponding subfield data and analyzes the image data to generate a variation of the image data and a variation of the data for each subfield. Also, an address power recovery operation determine unit compares the variation of the data for each subfield generated by the data variation calculator with a predetermined first threshold value to determine an operational status of the address power recovery circuit for each subfield. An address power recovery timing controller generates switch timing of the address power recovery circuit based on the operational status of the address power recovery circuit determined by the address power recovery operation determine unit. Additionally, a mode determine unit compares the variation of the image data generated by the data variation calculator with a predetermined second threshold value to generate gain control signals of the image data. Also, an image data gain controller controls a gain of the image data according to the signals generated by the mode determine unit and outputs them. An address data controller converts the image data from the image data gain controller into the corresponding subfield data to drive the plasma display panel and generates address data rearranged to correspond to address timing for each subfield. Also, an address electrode driver generates pulses for address discharging based on the address data from the address data controller to provide the pulses to the plasma display panel. The address electrode driver also drives the address power recovery circuit based on the switch timing generated by the address power recovery timing controller.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a general diagram that represents a PDP (plasma display panel) having a conventional tri-electrode structure.

FIG. 2 is a diagram that represents a capacitive component of a panel around address electrodes in a conventional PDP having the tri-electrode structure.

FIG. 3 is a graph that represents characteristics of address power consumed as images are displayed and the address power consumption recovery circuit is not operated.

FIG. 4(a) is a diagram that represents a dot ON/OFF image to which a lot of address pulse switching is applied.

FIG. 4(b) is a diagram that illustrates a full white image to which less address pulse switching is applied.

FIG. 5 is a diagram that illustrates analyzing data between upper and lower lines, and calculating a capacitance, Cx, in a method for controlling the address power on the PDP, according to an exemplary embodiment of the invention.

FIG. 6 is a diagram that illustrates analyzing data between right and left adjacent cells, and of calculating a capacitance, Ca, in the method for controlling the address power on the PDP, according to an exemplary embodiment of the invention.

FIG. 7 is a table that illustrates a status of operation and stoppage of the address power recovery circuit according to the size of APF (Address Power Factor) in a method for controlling the address power on the PDP according to one embodiment of the invention.

FIG. 8 is a diagram that illustrates an address electrode driving circuit of the conventional PDP.

FIG. 9 is a chart that illustrates switch timing when the address power recovery circuit is operated according to an exemplary embodiment of the invention.

FIG. 10 is a chart that illustrates switch timing when the operation of the address power recovery circuit is stopped according to an exemplary embodiment of the present invention.

FIG. 11 is a block diagram that illustrates an address power controller of the PDP according to an exemplary embodiment of the invention.

FIG. 12 is a detailed block diagram that illustrates a subfield number data determine unit in FIG. 11.

FIG. 13 is a graph that represents controlling gain of image data based on a size of the APFT (Address Power Factor Total) in the address power controller, according to an exemplary embodiment of the present invention.

FIG. 14 is a graph that represents controlling gain of imaged data with the passage of time according to an exemplary embodiment of the present invention.

FIG. 15 shows a graph for representing characteristics of address power consumption; (a) shows that the conventional address power recovery is not operated; (b) shows that the conventional address power recovery continues to be operated; and (c) shows a case of an address power recovery circuit selecting operation for each subfield and controlling the number of subfields according to an exemplary embodiment of the present invention.

### DETAILED DESCRIPTION OF THE PREFERRED EMBODIMENTS

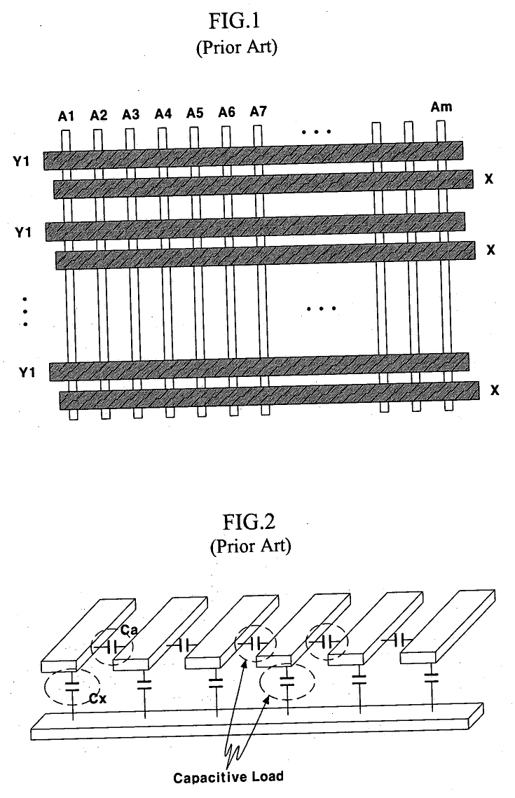

FIG. 1 is a diagram that illustrates a structure of a plasma display panel (PDP) having a conventional tri-electrode structure.

As shown in FIG. 1, the PDP of the tri-electrode structure includes scan electrodes (Y₁, Y₂, . . . , and Yₙ) for a scan function, a common electrode (X) for a sustain function, and address electrodes (A₁, A₂, . . . , Aₘ) for an address function. The scan electrodes (Y₁, Y₂, . . . , and Yₙ) and the common electrode (X) are arranged parallel on the front substrate of the PDP, and the address electrodes (A₁, A₂, . . . , Aₘ) are arranged crossing the scan electrodes (Y₁, Y₂, . . . , and Yₙ) and the common electrode (X) on the rear substrate of the PDP.

FIG. 2 is a diagram that illustrates a capacitive component of a panel around address electrodes arranged in a conventional PDP of a tri-electrode structure. As shown, the capacitive component of the panel includes capacitive components (Cₓ) between address electrodes, scan electrodes, and common electrodes, and capacitive components (Cₐ) between the address electrodes.

In this instance, the capacitive component (Cx) is defined by the sum of capacitive component (Ca_x) between the address electrode and the common electrode, and capacitive component (Ca_y) between the address electrode and the scan electrode.

In the PDP, an address pulse switching operation is generated based on display image data, and reactive power consumption is generated by charging/discharging on the capacitive components (Cₓ, Cₐ) of the panel based on the address pulse switching operation. The reactive power consumption is represented as C×V², where V is the power provided to the PDP, and C is the total capacitive component. The address power consumption varies according to the kinds of images displayed.

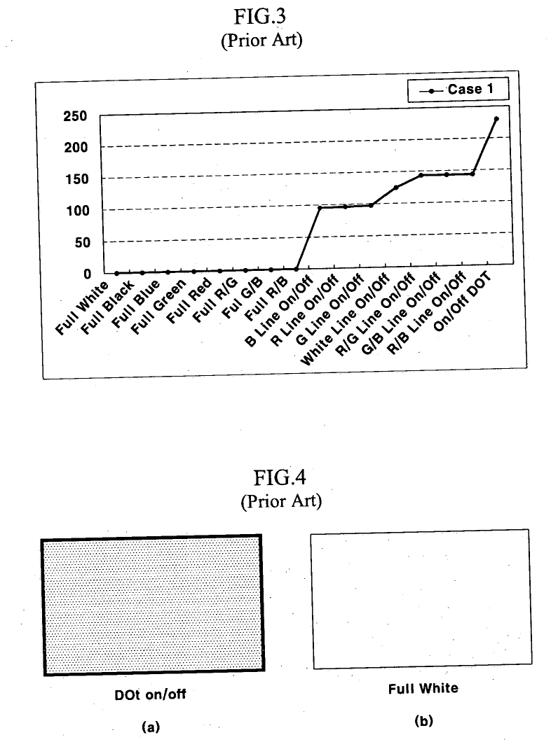

FIG. 3 is a graph that illustrates characteristics of address power consumed by displayed images when the address power consumption recovery circuit is not operated. As shown in FIG. 3, when displaying an image using fewer address pulse switching operations, for example, when displaying a full white image as shown in FIG. 4(b), power consumption is very low. When displaying an image with many address pulse switching operations, for example, when displaying an image in the dot ON/OFF as shown in FIG. 4(a), the address power consumption is substantially increased.

In the dot ON/OFF image shown in FIG. 4(a), the address power consumption is steeply increased because many variations are generated between up and down adjacent lines, and right and left adjacent cells. These variations create plural switching operations, which increases power consumption. In the full white image as shown in FIG. 4(b), few switching operations are generated because fewer variations between up and down adjacent lines and right and left adjacent cells are generated. Consequently, the power consumption is low.

When the address power consumption is high the load of an address driving IC is increased and the generation of heat rapidly increases. In this case, the generation of excess heat destroys the IC and degrades product reliability. Consequently, an address power recovery circuit is used in order to prevent the problems. However, as shown in FIG. 3, the power consumption of the display image in which the address power consumption is rapidly increasing is controlled to a some degree when the address power recovery circuit is used, but when an image without increased power consumption is displayed, the power recovery circuit continues to operate. As a result, the power consumption tends to increase instead of decrease.

Therefore, in an improvement over the conventional methods, an exemplary embodiment of the present invention, analyses images to be displayed on the PDP. General images in which the address power consumption of the PDP is not increased such as movies, dramas. Similarly, PC images are determined to be images in the normal mode, and dot ON/OFF images and line ON/OFF images in which the address power consumption of the PDP is rapidly increased are determined to be images in a specific mode and are differently controlled.

For display images determined to be images in normal mode, the address power recovery circuit operates only in individual subfields which require address power recovery, as indicated by an Address Power Factor(APF) value generated for each subfield. The power recovery circuit stops operating in the subfields which need no address power recovery.

For display images determined to be images in specific mode, the address power recovery circuit operates based on the APF value generated for each subfield to control the address power consumption. Additionally, the number of subfields for displaying images in specific mode is set to a number less than the number of the subfields for displaying the images in the normal mode. Because fewer subfields are used, power consumption decreases even for an image displayed in specific mode.

The APF is provided for each subfield, and is defined to be the sum of the capacitive components of the panel provided on the address electrodes, that is, the capacitive component (Cₓ) between the address electrode and the scan electrode/the common electrode, and the capacitive component (Cₐ) between the address electrodes as shown in [Equation 1].
APF=Cx+Ca [Equation 1]

Once the APF is generated for each subfield, it serves as a reference for determining a generational status of the address power recovery circuit of each subfield. That is, the address power recovery circuit operates and controls the subfields where APF is greater than a predetermined threshold value TH_apf. The address power recovery circuit stops operating and controlling subfields whose APF is less than the predetermined threshold value.

As shown in [Equation 2], the total sum of the APFs generated for the respective subfields is defined to be the Address Power Factor Total(APFT), and is used as a reference for determining whether images to be displayed on the PDP are the images in the normal mode or in the specific mode.

$$APFT = {\sum }_{SF = 1}^{N} APF ( SF ) \qquad [ Equation 2 ]$$

where SF represents the subfield and N represents the number of the subfields.

That is, the display image data is determined to be in the specific mode when the APFT is greater than a predetermined threshold value TH_apft. is the display data is determined to be in the normal mode when the APFT is less than the predetermined threshold value TH_apft.

A method for generating the capacitance, Cx, and the capacitance, Ca, which are components of the APF will be described.

First, Cₓ represents the sum of the capacitive components (Cₐ_{_{—}}ₓ) between the address electrodes and the common electrodes, and the capacitive components (Cₐ_{_{—}}_{y}) between the address electrodes and the scan electrodes. In one embodiment, a method for comparing the display data between the up and down lines of the display images converted to the subfield data is used in order to generate the Cx.

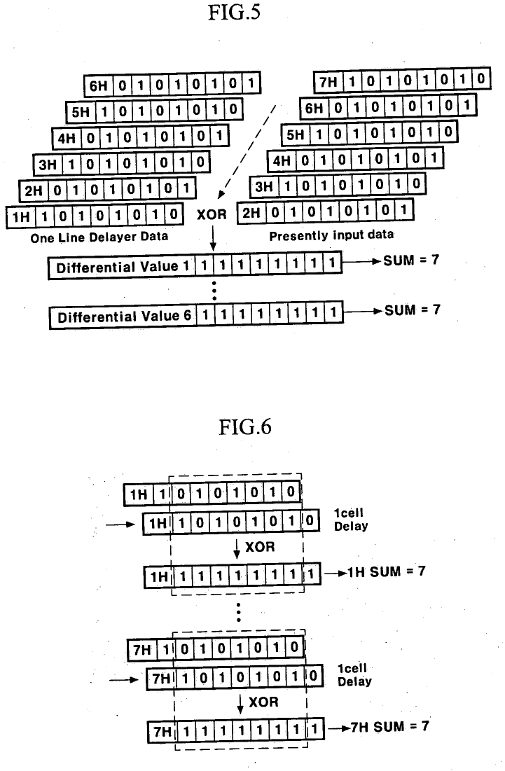

With reference to FIG. 5, data corresponding to one horizontal line is delayed for a period for displaying one horizontal line (generally one horizontal synchronous period, that is, one H_{sync} period), and each differential value generated when the delayed data are compared with current input horizontal line data by each cell is added to generate a variation value between two lines.

As described above, the sum of the differential values generated for each horizontal line represents Cₓ, when the differential value of each line to be displayed on a screen of the PDP is repeatedly added by N−1 number of times, wherein N is the number of display lines. Illustratively, Cₓ corresponding to a subfield is given as a differential value of R, G, B (red, green, and blue) of each pixel as shown in [Equation 3].

$$Cx\_sf = {\sum }_{i}^{} {\sum }_{j}^{} ( \vert {R}_{ij} - {R}_{( i + 1 ) j} \vert + \vert {G}_{ij} - {G}_{( i + 1 ) j} \vert + \vert {B}_{ij} - {B}_{( i + 1 ) j} \vert ) \qquad [ Equation 3 ]$$

In [Equation 3], a subtraction operation or an Exclusive OR(XOR) operation can also be used.

Cₐ represents a capacitive component between the address electrodes. In one embodiment, a method for comparing the data between tright and left adjacent cells from among the horizontal line data converted to the subfield data is used in order to generate the Cₐ.

As shown in FIG. 6, data corresponding to one horizontal line are delayed for a period of one cell and compared with original data, and the generated differential values are then added.

Thus, Cₐ represents the total sum of the differential values for the respective lines displayed on a PDP screen by repeatedly adding them N number of times, where N represents the number of display lines. Illustratively, the subtraction operation or the XOR operation is used to generate the differential values.

The display data is compared while generating the capacitive components Cₓ and Cₐ. Because the display data is data converted to the subfield data, the status of display data for each cell has either a status of ‘0’ or ‘1’. The status of ‘0’ represents the OFF status of discharge cells, and the status of ‘1’ represents the ON status of the discharge cells.

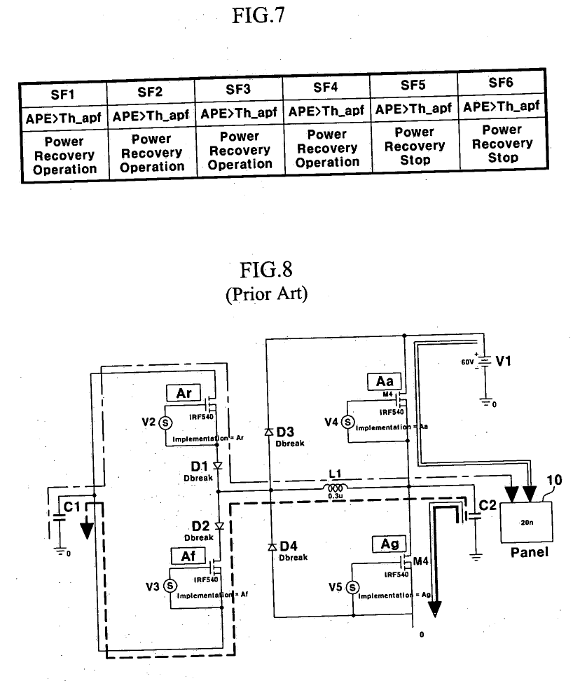

As shown, the APF of each subfield is generated by summing the CX and Ca generated for each subfield. The APF generated for each subfield is established to be a reference for determining whether to operate or stop the address power recovery circuit for each subfield. For example, as shown in FIG. 7, when the APF of a subfield is greater than a predetermined threshold value (TH_apf), the address power recovery circuit operates to control the first to fourth subfields (SF1, SF2, SF3, SF4), and when the APF is less than the predetermined threshold value (TH_apf), the address power recovery circuit does not operate for the fifth to sixth subfields (SF5, SF6).

FIG. 8 is a diagram illustrating an improved address electrode driving circuit for use in a conventional PDP. As shown, an address electrode driving circuit includes a power recovery circuit having a first FET (Aᵣ), a second FET (A_{f}), a capacitor (C₁), a first diode (D₁), a second diode (D₂), a signal source (V2) for providing a signal to the first FET (Aᵣ) and a signal source V₃ for providing a signal to the second FET (A_{f}). Additionally included are an address driver having a third FET (Aₐ), a fourth FET(A_{g}), a power source V₁ for providing power to the third FET (Aₐ), a signal source (V₄) for providing a signal to the third FET (Aₐ), and a signal source (V₅) for providing a signal to the fourth FET (A_{g}).

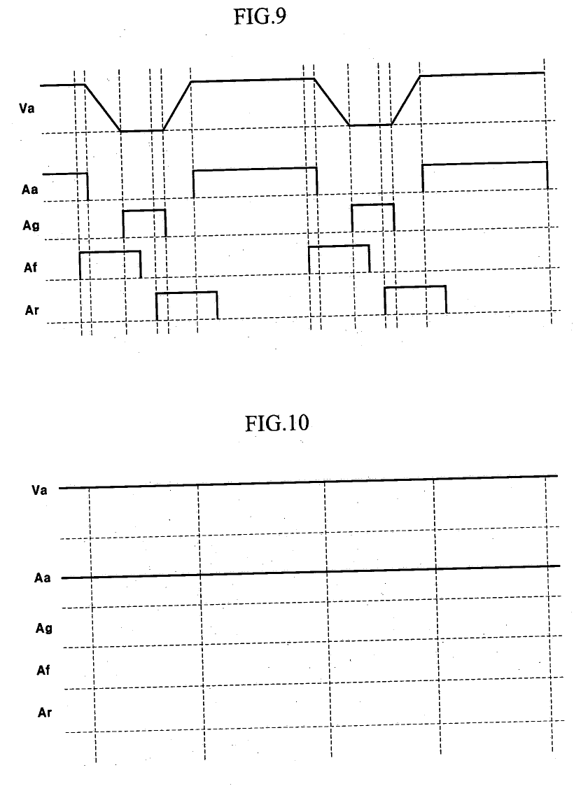

The APF generated for each subfield determines an operational status of the power recovery circuit of the address electrode driving circuit. The power recovery circuit is operated according to switch timing as shown in FIG. 9 when the generated APF is greater than the threshold value (TH_apf) of the APF, and is operated according to switch timing as shown in FIG. 10 when the generated APF is less than the threshold value (TH_apf) of the APF.

Operation of the address electrode driving circuit having an address power recovery circuit is now described with reference to FIG. 9. When the signal source (V₂) outputs a high signal to the first FET (Aᵣ), and the first FET (Aᵣ) is turned on, the capacitor (C₁) (charged by a discharge of the PDP panel 10) discharges a charged power, and the power level of the panel 10, especially, the level of the power (Vₐ) applied to the address electrode, increases.

The signal source (V₄) outputs a high signal when the level of the power (Vₐ) reaches a predetermined degree to turn on the third FET (Aₐ) and provide the address power to the panel 10. This increases the power (Vₐ) to a predetermined degree, and maintains the status for a determined time.

The signal source (V₄) outputs a low signal to turn off the third FET (Aₐ), and the signal source (V₃) outputs a high signal to turn on the second FET (A_{f}), to charge capacitor (C₁) with the power discharged from the panel 10.

When the capacitor (C₁) is charged, the signal source (V₅) outputs a high signal to turn on the fourth FET (A_{g}) and stops providing power to the panel 10.

The address electrode driving operation and the address power recovery operation are performed by repeating the steps as shown above.

As shown in FIG. 10, no signals are provided to the first FET (Aᵣ), the second FET (A_{f}) and the fourth FET (A_{g}) for charging and discharging the address driving voltage together with the address power recovery circuit. A high signal is provided to the first FET (Aₐ) is used for driving the panel 10 to turn on the first FET (Aₐ) so that the predetermined level of the voltage (Vₐ) may be supplied to the panel 10. In other words, the address power recovery circuit ceases operation.

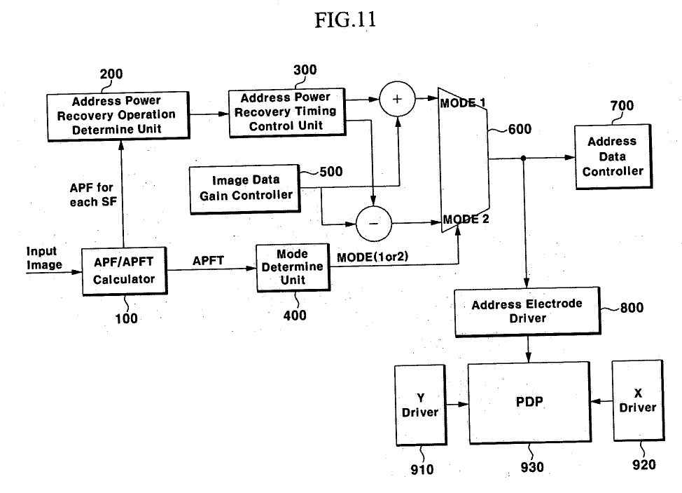

FIG. 11 is a block diagram for an address power controller of the PDP according to an exemplary embodiment of the invention. As shown, a PDP address power controller according to an exemplary embodiment of the present invention includes an APF/APFT calculator 100, an address power recovery operation/stop determine unit 200, an address power recovery timing controller 300, a mode determine unit 400, an image gain controller 500, an address data controller 600, an address electrode driver 700, and a driving controller 800.

The APF/APFT calculator 100 receives image data and converts the data to subfield data, generates capacitive components of the address electrodes for each subfield, adds them to calculate APF for each subfield, Cₓ and Cₐ, and adds the APF for each subfield to calculate the APFT.

The address power recovery operation/stop determine unit 200 receives APF for each subfield calculated by the APF/APFT calculator 100 and compares them to the threshold value TH_apf of the APF to determine whether the address power recovery circuit is operated or stopped.

The address power recovery timing controller 300 generates switch timing as shown FIG. 9 or FIG. 10 based on operation or non-operation of the address power recovery circuit as determined by the address power recovery operation/stop determine unit 200.

The mode determine unit 400 receives the APFT generated by the APF/APFT calculator 100 and determines whether images to be displayed are images in the normal mode or in the specific mode and outputs a signal (mode) representing the determination results. At this time, the mode determine unit 400 outputs a Mode 1 signal in the normal mode and Mode 2 signal in the specific mode.

The image gain controller 500 receives the image data, controls the gain according to the signals (mode) output from the mode determine unit 400, and outputs them. When the signal from the mode determine unit 400 is a signal of Mode 1 which represents the normal mode signal, the gain of the input image data is output without being controlled, but the gain of the input image data is controlled to be output when the signal from the mode determine unit 400 is a signal of Mode 2 which represents the specific mode signal. At this time, the image data gain controller 500 controls the gain of the input image data based on the time or the APFT output from the APK/APFT calculator 100.

When the signal from the mode determine unit 400 is a signal of Mode 1, which represents the normal mode signal, the selector 600 selects a signal to output from the address power recovery timing controller 300 that includes image data in which gain is not controlled by the image data gain controller 500. When the signal from the mode determine unit 400 is a signal of Mode 2, which represents the specific mode signal, the selector 600 selects a signal from the address power recovery timing controller that includes image data in which gain is controlled by the image data gain controller 500. In one embodiment, a 2×1 multiplexer which selects one input data of the two input data and output it is used for the selector 600.

The address data controller 700 converts the image data selected and output by the selector 600 into subfield data used to drive the PDP. The address data controller 700 also generates address data rearranged to correspond to the address timing for each subfield, and outputs them.

The address electrode driver 800 drives the address power recovery circuit based on the signal output from the address power recovery timing controller 300. In one embodiment, the output signal is selected and output by the selector 600. The address electrode driver may also generate the pulse for initiating address discharges based on the address data received from the address data controller 700, and provide the pulses to the PDP 930.

The Y driver 910 and X driver 920 generate pulses for driving the scan electrode (Y1, Y2, . . . , Yn) and the common electrode (X) to provide them to the PDP 930.

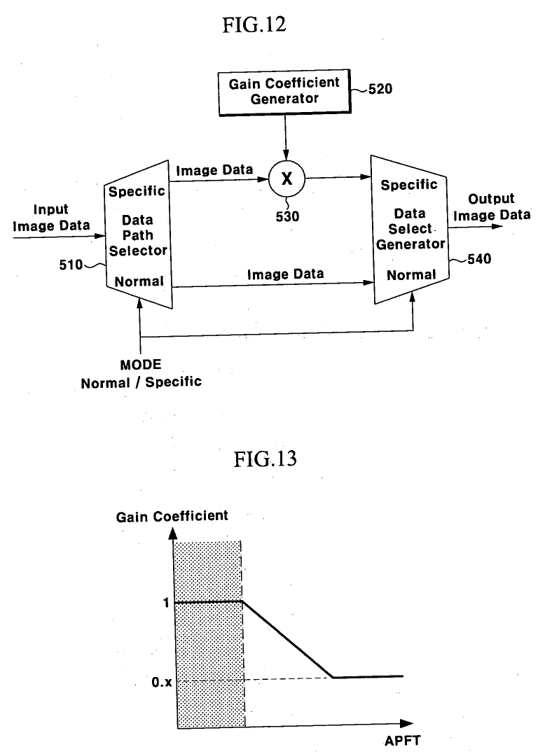

FIG. 12 shows a detailed block diagram for an image data gain controller 500 shown in FIG. 1.

As shown in FIG. 12, the image data gain controller 500 includes a data path selector 510, a gain coefficient generator 520, a multiplier 530, and a data select output unit 540.

The data path selector 510 selects different paths for input image data based on the signal (mode) from the mode determine unit 400. That is, the data path selector 510 selects the path to output the input image data directly to the data select output unit 540 when the signal from the mode determine unit 400 is a signal of Mode 1 which represents the normal mode signal, and the path to output the image data to the multiplier 530 when the signal from the mode determine unit 400 is a signal of Mode 2 which represents the specific mode signal.

The gain coefficient generator 520 generates a coefficient for controlling the gain when the input image data are the image of the specific mode. The value of the gain coefficient generated by the gain coefficient generator 520 is established to be between the values of 1 and 0.0.

Although the gain coefficient generator 520 may generate the gain coefficients in various ways, in this exemplary embodiment of the present invention, the methods are described assuming that the gain coefficient is generated by either a method based on the magnitude of the APFT output from the APF/APFT calculator 100 or a method based on time.

As shown in FIG. 13, in the method based on the magnitude of the APFT, the APF/APFT calculator 100 generates a gain coefficient that is generated in inverse proportion to the magnitude of the APFT. That is, the greater the magnitude of the APFT is, the smaller the gain coefficient is. On the other hand, the smaller the magnitude of the APFT, the greater the gain coefficient is. Additionally, the relatively smaller gain coefficient is generated when the variation of the display image data is great. Because the variation of the display image data is relatively small when the APFT is great, the gain must be controlled so that the number of active subfields may be reduced in comparison with in a case having a smaller APFT.

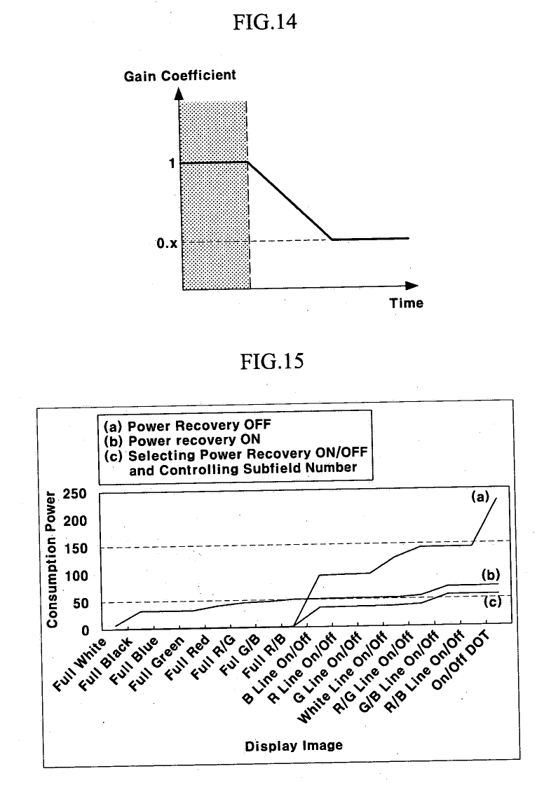

As shown in FIG. 14, a second method based on time reduces a generated gain coefficient as time passes for a predetermined time period. That is, the gain of the image data is controlled to be reduced temporally. The time information may be established in one of many ways. For example, the time may be from a time when image data is input. Also, the gain of the image data may be reduced gradually or stepwise as time passes.

The multiplier 530 multiplies the image data output from the data path selector 510, by the gain coefficient generated by the gain coefficient generator 520, and outputs them to the data select output unit 540.

The data select output unit 540 selects between the image data directly output by the data path selector 510 in which the gain is not controlled and the image data with the controlled gain output by the multiplier 530, and outputs its selection to the selector 600. At this time, the data select output unit 540 selects and outputs the image data form the data path selector 510 when the signal from the mode determine unit 400 is a signal of Mode 1, which represents the normal mode signal. But when the signal from the mode determine unit 400 is a signal of Mode 2, which represents the specific mode signal, the data select output unit 540 selects and outputs the image data from the multiplier 530.

The image data gain controller 500 according to the exemplary embodiment of the present invention uses one of the gain control methods based on the above described APFT or the gain control method based on time, or uses both of them.

FIG. 15 is a graph that represents characteristics of address power consumption; (a) shows that the conventional address power recovery is not operated; (b) shows that the conventional address power recovery circuit continues to be operated; and (c) shows a case of an address power recovery circuit selecting operation in each subfield and controlling the number of subfields according to an exemplary embodiment of the present invention.

As shown in FIG. 15(a), the power consumption of the image with less address pulse switching operations is very low, and the power consumption of the images with many address pulse switching operations is greatly increased.

As shown in FIG. 15(b), the power consumption is reduced in the images to which a lot of address pulse switching operations are applied in comparison with (a), but is increased in the images to which less address pulse switching operations are applied in comparison with (a) when the address power recovery circuit is operated.

As shown in FIG. 15(c), when the address power recovery circuit is selectively operated for each subfield and the data gain is controlled in the specific mode, the power consumption is very low because the power recovery circuit is stopped for the images with less address pulse switching operations. Thus, the power consumption is much reduced in comparison with FIGS. 15(a) and 15(b). because the power recovery circuit is controlled based on the data gain. Therefore, the method according to the exemplary embodiment of the present invention most effectively controls the address power consumption.

While this invention has been described in connection with what is presently considered to be practical and preferred embodiments, it is to be understood that the invention is not limited to the disclosed embodiments, but, on the contrary, is intended to cover various modifications and equivalent arrangements included within the spirit and scope of the appended claims.

1. A method for controlling address power on a plasma display panel having an address power recovery circuit, comprising:
converting image data to be displayed on the plasma display panel into corresponding subfield data;
analyzing the converted subfield data to generate a variation of the data for each subfield;
stopping the operation of the address power recovery circuit for each subfield having data variations less than a predetermined first threshold value; and
operating the address power recovery circuit for each subfield having data variations greater than the predetermined first threshold value.

2. A method for controlling address power on a plasma display panel comprising an address power recovery circuit, comprising:
converting image data to be displayed on the plasma display panel into corresponding subfield data;
analyzing the converted subfield data to generate a variation of the image data;
controlling the gain of the image data when the generated variation of the image data is greater than a predetermined second threshold value.

3. The method of claim 2, wherein analyzing the converted subfield data further comprises:
adding the generated variation of the data for each subfield to all subfields to generate the variation of the image data.

4. The method of claim 1, wherein the variation of the data for each subfield represents an address power factor of each analyzed subfield.

5. The method of claim 4, wherein the address power factor includes variation of the data between up and down horizontal lines in the images.

6. The method of claim 4, wherein the address power factor includes variation of the data between right and left adjacent cells in the images.

7. The method of claim 4, wherein the address power factor represents the sum of capacitive components on the address electrodes provided on the plasma display panel.

8. The method of claim 7, wherein the capacitive component on the address electrodes represents the sum of capacitive components between the common electrode and the scan electrode provided on the plasma display panel, the capacitive components between the common electrode and the address electrode, and the capacitive components between the address electrodes.

9. A method for controlling address power on a plasma display panel having an address power recovery circuit, comprising:
converting image data to be displayed on the plasma display panel into corresponding subfield data;
analyzing the converted subfield data to generate a variation of the image data and a variation of the data for each subfield;
controlling a gain of the image data and operating the address power recovery circuit when the generated variation of the data for each subfield is greater than a predetermined first threshold value and the generated variation of the image data is greater than a predetermined second threshold value;
operating the power recovery circuit without controlling the gain of the image data when the generated variation of the data for each subfield is greater than the predetermined first threshold value and the generated variation of the image data is less than the second threshold value.
controlling the gain of the image data without operating the address power recovery circuit when the generated variation of the data for each subfield is less than the predetermined first threshold value and the generated variation of the image data is greater than the second threshold value.

10. The method of claim 2, wherein the gain of the image data is controlled by a gain coefficient determined on the basis of the magnitude of the variation of the image data.

11. The method of claim 10, wherein the gain coefficient is determined to be in inverse proportion to the magnitude of the variation of the image data.

12. The method of claim 2, wherein the gain of the image data is controlled by the gain coefficient determined on the basis of time.

13. The method of claim 12, wherein the gain coefficient is reduced as time passes.

14. An apparatus for controlling address power on a plasma display panel having an address power recovery circuit, the apparatus comprising:
a data variation calculator for converting image data to be displayed on the plasma display panel into corresponding subfield data, and for generating a variation of the data for each subfield;
an address power recovery operation determine unit for comparing the variation of the data for each subfield with a predetermined first threshold value to determine an operational status of the address power recovery circuit for each subfield;
an address power recovery timing controller for generating switch timing of the address power recovery circuit based on the operational status of the power recovery circuit; and
an address electrode driver for controlling driving the address power recovery circuit based on the switch timing generated by the address power recovery timing controller.

15. An apparatus for controlling address power on a plasma display panel having an address power recovery circuit, the apparatus comprising:
a data variation calculator for converting image data to be displayed on the plasma display panel into corresponding subfield data, for analyzing the subfield data, and for calculating a variation of the image data;
a mode determine unit for comparing the variation of the image data calculated by the data variation calculator with a predetermined second threshold value to generate gain control signals of the image data;
an image data gain controller for controlling and outputting the gain of the image data based on the signals generated by the mode determine unit;
an address data controller for converting the image data output by the image data gain controller into the corresponding subfield data for driving the plasma display panel, and generating address data rearranged to correspond to the address timing for each subfield; and
an address electrode driver for generating pulses for address discharging based on the address data output from the address data controller, and for supplying the pulses to the plasma display panel.

16. An apparatus for controlling address power on a plasma display panel having an address power recovery circuit, the apparatus comprising:
a data variation calculator for converting image data to be displayed on the plasma display panel into corresponding subfield data, for analyzing the subfield data, and for generating a variation of the image data and a variation of the data for each subfield;
an address power recovery operation determine unit for comparing the variation of the data for each subfield calculated by the data variation calculator with a predetermined first threshold value to determine an operational status of the address power recovery circuit for each subfield;
an address power recovery timing controller for generating switch timing of the address power recovery circuit based on an operational status of the address power recovery circuit determined by the address power recovery operation determine unit;
a mode determine unit for comparing the variation of the image data calculated by the data variation calculator with a predetermined second threshold value to generate gain control signals of the image data;
an image data gain controller for controlling and outputting the gain of the image data based on the signals generated by the mode determine unit;
an address data controller for converting the image data output from the image data gain controller into the corresponding subfield data for driving the plasma display panel, and generating address data rearranged to correspond to the address timing for each subfield; and
an address electrode driver for generating pulses for address discharging based on the address data output from the address data controller, for supplying the pulses to the plasma display panel, and for controlling driving the address power recovery circuit based on the switch timing from the address power recovery timing controller.

17. The apparatus of claim 14, wherein the address power recovery operation determine unit does not operate the address power recovery circuit when the variation of the data for each subfield is less than the predetermined first threshold value, and operates that the address power recovery circuit when the variation of the data for each subfield is greater than the predetermined first threshold value.

18. The apparatus of claim 15, wherein the mode determine unit generates signals which do not control gain of the image data when the variation of the image data is less than the predetermined second threshold value, and generates signals for controlling the gain of the image data when the variation of the image data is greater than the predetermined second threshold value.

19. The apparatus of claim 18, wherein the image data gain controller controls the gain of the image data based on the gain coefficient determined on the basis of a magnitude of the generated variation of the image data when the signals for controlling the gain of the image data are generated by the mode determine unit.

20. The apparatus of claim 18, wherein the image data gain controller controls the gain of the image data based on the gain coefficient determined based on time when the signals for controlling the gain of the image data are generated by the mode determine unit.
